(19) United States
(12) Patent Application Publication
(10) Pub. No.: US 2017/0106979 A1
(43) Pub. Date: Apr. 20, 2017

(54) Receiver of Objects from Aerial Machines

(71) Applicant: Daniel Ernest Seger, Laurel, MD (US)

(72) Inventor: Daniel Ernest Seger, Laurel, MD (US)

(21) Appl. No.: 14/918,021

(22) Filed: Oct. 20, 2015

(51) Int. Cl. B64D 1/12; B64D 1/14; B64C 39/02; F16M 13/02

(52) U.S. Cl. CPC B64D 1/12; F16M 13/02; F16M 13/027; B64D 1/14; B64C 39/024; F16M 2200/04; B64C 2201/141; B64C 2201/128

(57) ABSTRACT

The present invention is a machine that connects to, or near, an opening of a dwelling that is capable of receiving objects from aerial delivery machines.

### BACKGROUND AND SUMMARY OF INVENTION

### Background

In the not-too-distant future, deliveries will be carried out by flying autonomous machines, or drones. The automation of deliveries, while substantially faster and more efficient, also presents a number of challenges for the industry. A major challenge will be to deliver to apartments above the first floor, or even those on the first floor. This problem is due to population density. A drone could be sent to the same GPS coordinates for multiple individuals. Depending on the number of residents in a given building, huge numbers of drones could even arrive at the same time, creating a dangerous situation. The increased population density also increases the likelihood that people will be in the path of the drone, preventing it from carrying out its mission. These problems will be compounded in the coming years as populations swell and land becomes increasingly scarce. The present invention provides a way for drones to make deliveries to these, or any, building without any of the problems mentioned above.

Imagine a world with no delivery problems, no signatures required, no lazy/clumsy delivery men/women, no picking your delivery up at the lobby, no sticky-note notifications saying you now have to drive 30 minutes to pick up your delivery from a warehouse, and no other hassles whatsoever. The present invention makes that world possible.

### SUMMARY

The present invention would allow for a future in which deliveries are carried out by drones. Following an order, a delivery drone would be dispatched. When it is close to its destination, it sends out an incoming signal. That signal is picked up by a machine, the present invention, located outside the window of a dwelling that responds by communicating its precise location to the drone and readying itself to receive a delivery. The drone moves to and hovers just above the machine, doing a final check to ensure it is safe to transfer its cargo. Once all safety checks are cleared, the drone gently transfers its cargo to the machine, and signals that the delivery is complete. The machine then responds to that signal by protecting its cargo from any strong winds, from the sun, and from inclement weather. An operator would then receive a notification on his/her smart-device that a delivery has been made and is waiting for him/her to open the window and retrieve it.

### BRIEF DESCRIPTION OF DRAWINGS

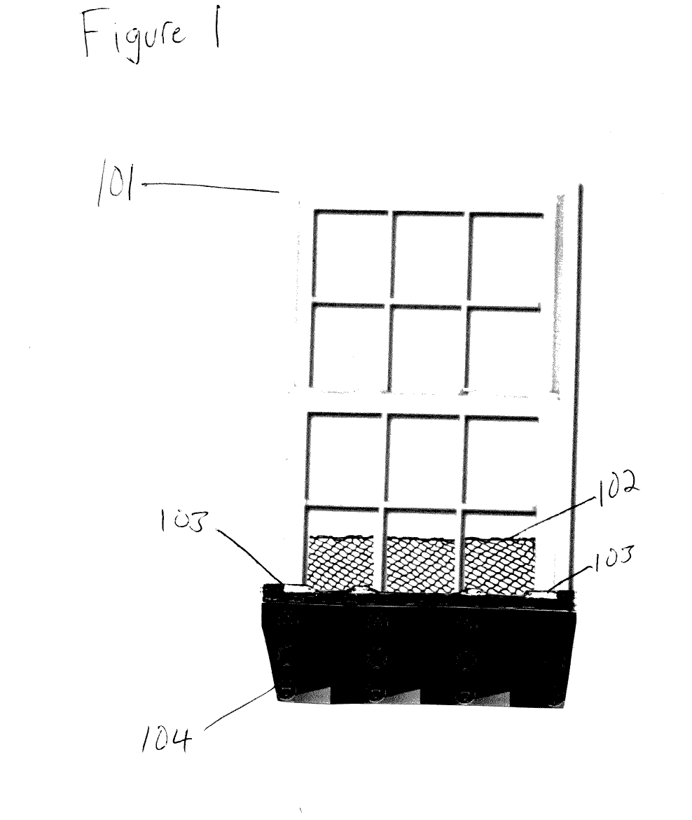

Introduced in FIG. 1:

101—Window as seen from inside the dwelling.

102—Net seen through the window

103—Sealing and locking mechanism

104—The control panel

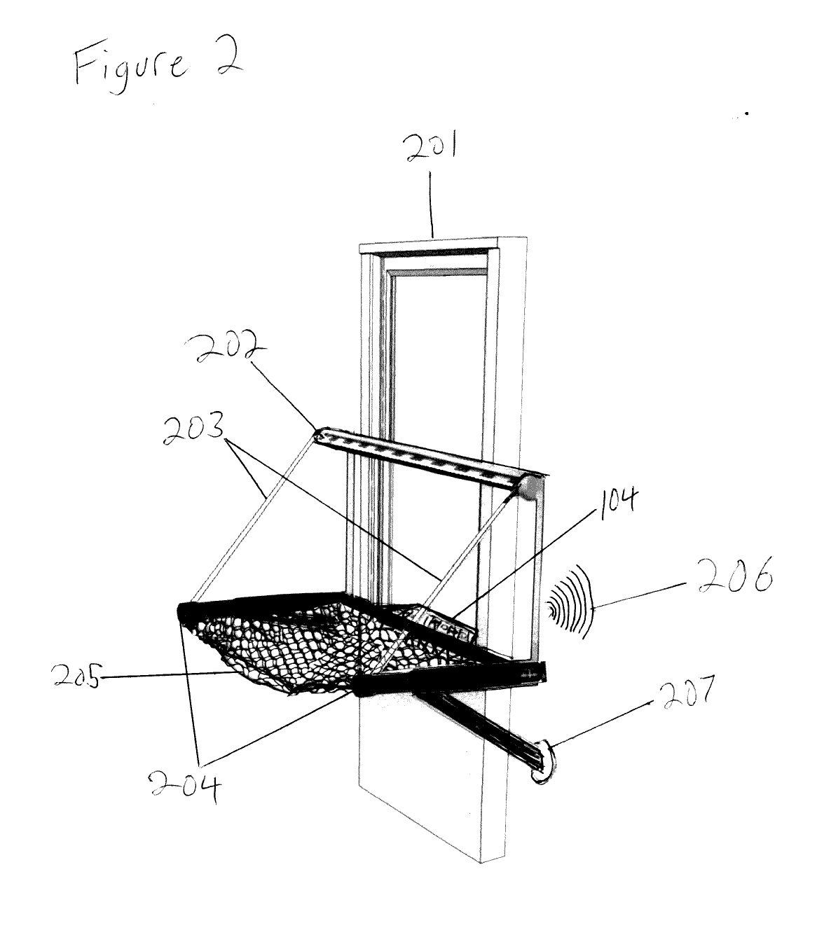

Introduced in FIG. 2:

201—Window as seen from outside the dwelling

202—Retracted cover

203—The cover's connections to the end of the rods

204—Retracted rods

205—Retracted net

206—Communications with supplier, delivery machine, and/or the operator

207—Counterbalancing supports

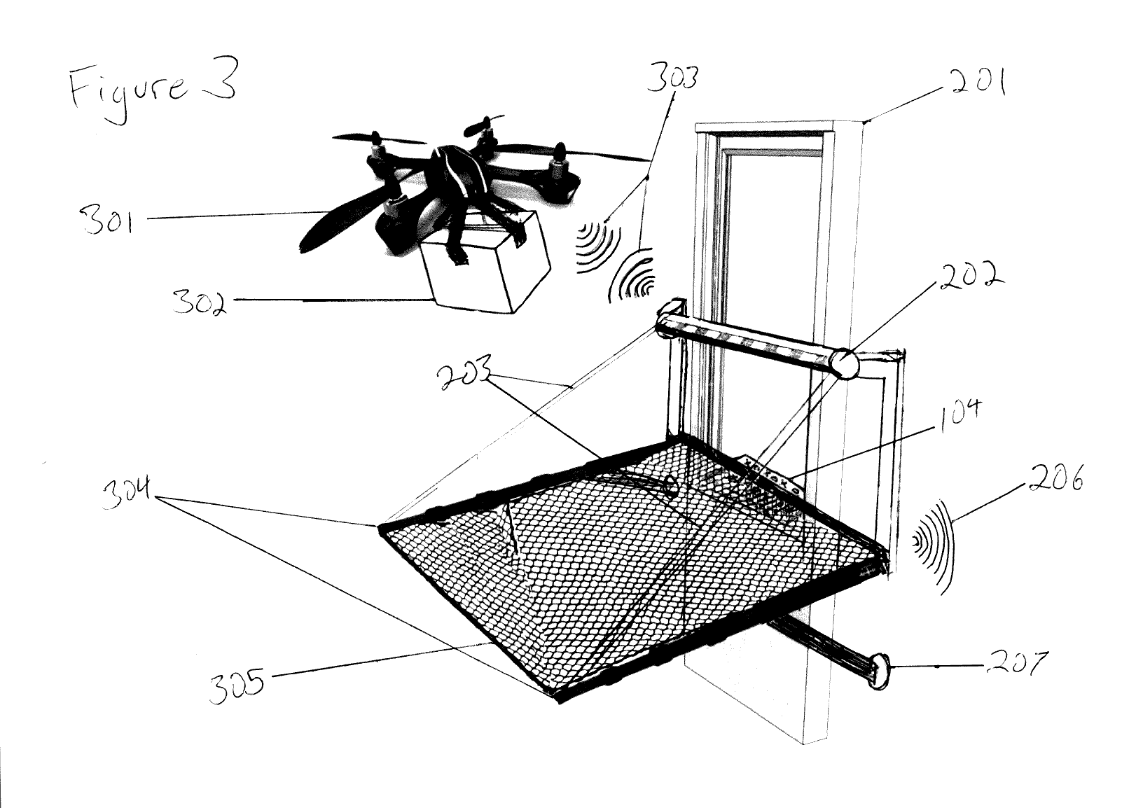

Introduced in FIG. 3:

301—Aerial delivery machine

302—Object to be delivered

303—Communication between machine and aerial delivery machine

304—Fully extended rods

305—Fully extended net

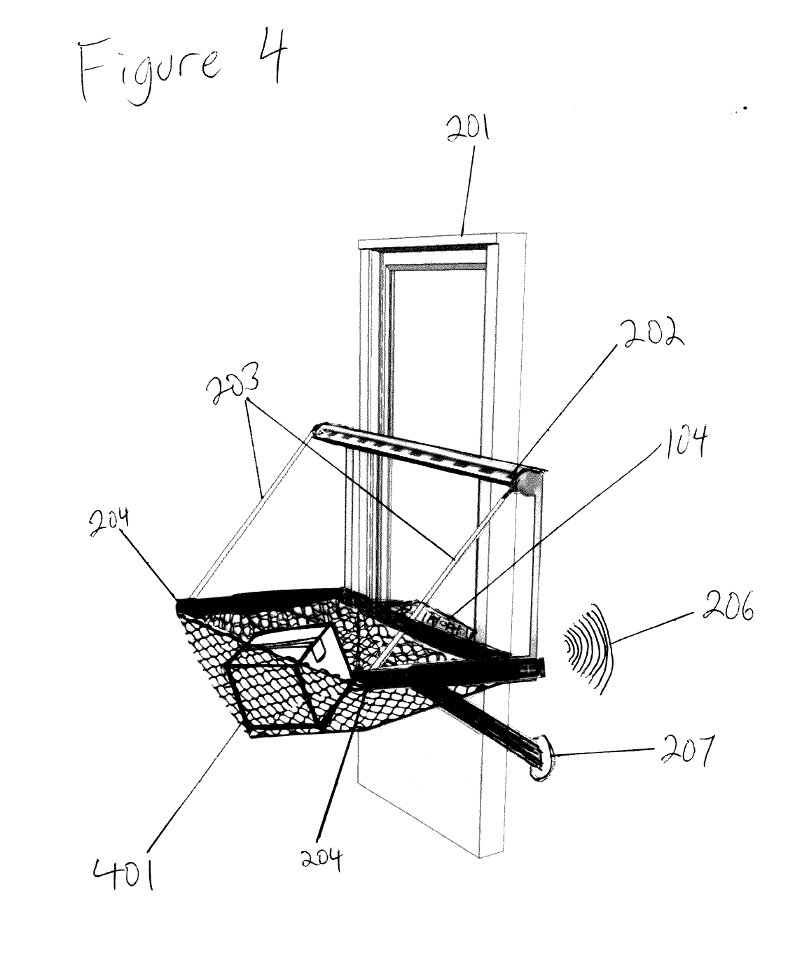

Introduced in FIG. 4:

401—Fully secured delivered object

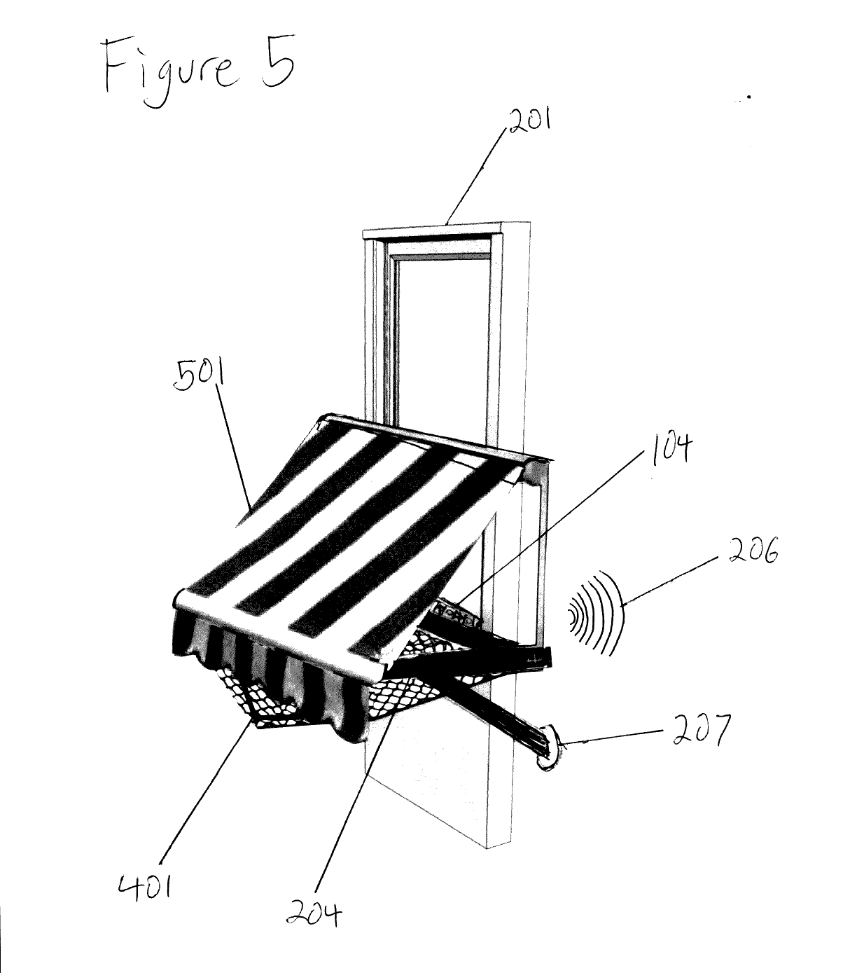

Introduced in FIG. 5:

501—Fully extended cover

### DETAILED DESCRIPTION OF INVENTION:

It is understood that the present invention is not limited to the described preferred embodiments of it. In the pictured preferred embodiments, the present invention is designed to mount on an existing window. Part of the machine sits on the interior of the window sill, which includes the control panel (104). The machine could be hard-mounted to the interior window sill if needed or desired to provide the appropriate level of security and stability. It could also be shaped in a way that it would be secured by the window itself, such as how an air conditioner is secured to a window. The control panel, or means of operating the machine, is located conveniently for the user on top of this part of the machine, just inside the window (104). While it is shown being placed horizontally across the window sill, it could just as easily be oriented vertically and/or next to the window. While a touch-panel is pictured (104), controls for the machine could be of varying types, such as levers or buttons. The machine interfaces with the window such that the window retains its functionality, including creating a weather-tight seal and locking (103).

On the outside of the opening, in this case a window (FIGS. 2-5), the machine has two extendable (304) and retractable rods (204), one on either side of the bottom of the window (201) where it opens. These rods are equipped with counter-balancing supports that create triangles with the building outside the window for additional support (207).

Connected to these retracted rods (204) is a retracted net (205). When the machine is signaled that a delivery is incoming (206), it extends the retracted rods outward away from the window (304), thereby extending the net such that it becomes ideal for receiving an object (305). The machine signals that it is ready to receive a delivery (303). The rods and net extend far enough (304 & 305) that an aerial delivery machine can get close enough to deliver an object into the net (301).

Once the object is delivered, the drone signals the machine again (303), which triggers the rods and net to retract (204 & 205) with the object caught in the net. The rods and net retract until the net supplies sufficient force to the package to keep it in place in the event of heavy winds, but not so much as to damage the package or its contents (401). A cover (202) connected to the ends of the retracting rods (203) then extends to protect the delivered object from the sun, rain, hail, snow, sleet, freezing rain, and small meteorites (501). The owner of the object is notified by the machine that a delivery has arrived and even reminded what was delivered (206). The machine holds the object safely in the net until a user retrieves it.

Additional functionality could be built into the device such that it communicates with delivery companies, and/or delivery drones, (206) to indicate to them if the machine can support additional deliveries. This would prevent wasted trips and/or an overloaded machine in the event the owner of the objects cannot retrieve them for a length of time, such as if he or she went on an extended vacation.

1. A method for receiving objects from an aerial delivery machine that includes the following:
a. A means of securing said machine to and/or near a building such that said machine, and/or any part of said machine, is accessible to a user from inside said building, from/via an opening in said building, from the ground, and/or from/via a surface connected to, and/or near, said building such as, but not limited to, a window, door, porch, deck, lawn, balcony, and/or roof.
b. An apparatus capable of receiving objects from an aerial delivery machine.
c. A mechanism that enables said machine to secure said delivered objects within it, thus keeping said objects securely in place until an operator releases them.

2. The method of the above claim in which said machine also consists of any combination, including all or none, of the following:
a. A means of detecting said machine's remaining capacity to safely accept additional objects.
b. A means of covering delivered objects to protect them from the elements that may or may not include air conditioning or refrigeration.
c. A means of sending, processing, and/or receiving information to and/or from aerial delivery machines or other instruments capable of sending and/or receiving information.
d. A means for an operator to interact with and/or control said machine and/or its parts.

3. The method from the above claims in which said machine is secured, attached, or otherwise fastened (1a), by any means, to an external opening of a building, any inside or outside wall of a building, the floor of a building, the ceiling of a building, the roof of a building, the ground near a building, and/or any other object and/or structural element on or near a building or property.

4. The method of the above claims in which said means of securing said machine (1a) is achieved via any means, including, but not limited to: screws, bolts, nails, glue, weight distribution of said machine, counterweights added to said machine, size and/or shape of said machine and/or its parts, any protrusions from said machine, and/or any combination thereof.

5. The method from the above claims in which said means of securing (1a) said machine may be to incorporate said machine directly into the structure of said building such that said machine may be, may encompass, and/or may partially encompass, an opening to said building.

6. The method from the above claims in which said receiving apparatus (1b) is comprised, or partially comprised, of a retractable, stationary, folding, and/or otherwise moveable net, platform, pinching apparatus, as in apparatus, us or any other mechanism/method ca able of f receiving and/or securing object(s).

7. The method from the above claims in which said receiving apparatus (1b) and/or said securing mechanism (1c), and/or any of said machine's parts, operates to receive and/or secure objects automatically, manually, in response to signals from an aerial delivery machine, and/or signals from other service or devices capable of communicating with said machine via any means, and/or via any combination thereof.

8. The method from the above claims in which the means of detecting its remaining capacity (2a) is achieved through collection and/or analysis of any type of data including, but not limited to: size of an object, weight of an object, number of objects, communications from a delivery machine, other information not listed here, or any combination of methods.

9. The method from the above claims in which said means of covering objects (2b) of said machine employs a retractable, folding, sliding, closing, and/or stationary cover to protect delivered objects from inclement weather.

10. The method from the above claims in which said means of covering objects (2b) is made of any material and is, at any point during its operation, configured in any shape and/or any size.

11. The method from the above claims in which said means of covering objects (2b) may create a seal around a delivered object, via any means and of any quality, that would allow for better protection for objects and/or for heating and/or cooling of the air around said object.

12. The method from the above claims in which said machine, and/or any of its parts, receives and/or processes, and/or transmits, communication of any kind (2c), such as, but not limited to: radio waves, symbols, bar codes, quick response (QR) codes, lasers, tones or sounds, etc., that communicate any kind of information, such as, but not limited to:
identifying information such as a name or address, said machine's platform size or remaining weight capacity, a GPS location, battery level, malfunctions, delivery notifications, information on what a package contains, etc.

13. The method from the above claims in which said machine and/or any of its parts may process said communication (2c) via any means.

14. The method from the above claims in which said machine and/or any of its parts may send and/or receive said communication (2c) via any means such as, but not limited to:
via radio waves, wireless fidelity (Wi-Fi), Bluetooth, magnetic resonance, etc., to any recipient for any purpose.

15. The method from the above claims in which said means of interacting and controlling said machine (2d) could include, but is not limited to, a touch screen, a computer program, a digital interface, a program running on another device, gesture recognition, voice recognition, timers, automation, proximity recognition, an app, reels, buttons, knobs, levers, switches, other mechanical controls, other means of controlling a machine not listed here, or any combination thereof.

16. The method from the above claims in which said means of interacting and controlling said machine (2d) allows a user to control one or more of said machine's functions.

17. The method from the above claims in which any and/or all of said machine's retracting, folding, sliding, opening, closing, and/or stationary mechanisms are operated manually, and/or automated, and/or mechanically operated by any means.

18. The method from the above claims in which said machine is able to extend any, or all, of its retracting parts to any distance, to create any size shape, and/or at any speed.

19. The method from the above claims in which said machine is located entirely outside, partially outside, and/or entirely inside the building at any time during its operation, and when desired can create a locked seal, of any quality, with said building opening by any means.

20. The method from the above claims in which said machine is powered by any means, such as, but not limited to: solar powered, battery-powered, wired directly into the building's electrical system, wireless induction, magnetic resonance, plugged into an outlet, other means not listed here, and/or any combination thereof.

21. The method from the above claims in which said machine, and/or any of its parts, at any time during its operation, consists of any number and/or any combination of materials of any strength, size, thickness, color, or shape.
